(19) United States
(12) Patent Application Publication
(10) Pub. No.: US 2009/0167954 A1
(43) Pub. Date: Jul. 2, 2009

(54) MOVING IMAGE PROCESSING CIRCUIT AND CELLULAR PHONE WITH THE SAME

(75) Inventors: Kyungwoon Jang, Kanagawa (JP); Kazuhiro Myoken, Tokyo (JP); Hidenao Bito, Kanagawa (JP); Toshiya Takahashi, Chiba (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/341,898

(22) Filed: Dec. 22, 2008

(30) Foreign Application Priority Data
Dec. 27, 2007 (JP) 2007-337494

(51) Int. Cl. H04N 9/65; H04M 1/00

(52) U.S. Cl. 348/642; 455/556.1; 348/E09.045

(57) ABSTRACT

A moving image processing circuit is provided includes: a decode processing unit configured to decode moving image data encoded by a predetermined compression method; an RGB conversion processing unit configured to convert the color space of the decoded moving image data to an RGB color space; a graphic processing unit configured to graphically process the moving image data whose color space is converted; and a control unit configured to control the decode processing unit, the RGB conversion processing unit and the graphic processing unit and select a frame leading to a drop frame.

This application claims the benefit of Japanese Application No. 2007-337494 filed in Japan on Dec. 27, 2007, the contents of which are incorporated herein by this reference.

### BACKGROUND OF THE INVENTION

1. Field of the Invention

The present invention relates to a moving image processing circuit and, in particular, to a moving image processing circuit including a decode processing unit configured to decode moving image data encoded by a predetermined compression method, a color space conversion processing unit configured to convert the color space of the decoded moving image data to a different color space and a graphic processing unit configured to graphically process the moving image data whose color space is converted, and a cellular phone including the moving image processing circuit.

2. Description of the Related Art

In recent years, a digital moving image shot by a video camera and a digital moving image received from a digital broadcast has been subjected to a predetermined graphic processing and then displayed, instead of directly displaying the digital moving images on a display apparatus such as a liquid crystal display (hereinafter, referred to as “LCD”).

The digital moving image is compressed by a predetermined compression method, in other words, encoded to reduce the capacity and correct an error, and recorded in a recording medium or delivered through the Internet circuit or broadcast. For this reason, a decode processing unit is used which is configured to decode the moving image data encoded by the predetermined compression method and to be turned into the moving image data being the aggregation of images on a frame basis to reproduce the digital moving image data.

The color space for displaying a color image includes various systems. The systems have advantages and disadvantages. An optimum system is used according to purposes. For example, a YUV color space (hereinafter, referred to as “YUV”) is used as the color space in a broadcast field. An RGB color space (hereinafter, referred to as “RGB”) is used as the color space for the graphic processing.

For this reason, in order that the decoded moving image data is subjected to the predetermined graphic processing, a moving image processing circuit is required including a color space conversion processing unit configured to convert the moving image data represented in the YUV color space (hereinafter, referred to as “YUV data”) to the moving image data represented in the RGB color space (hereinafter, referred to as “RGB data”) before the graphic processing as well as a graphic processing unit configured to subject the converted RGB signal to the graphic processing. Subjecting a video signal with a frame rate of 30 fps to the decode processing, the color space conversion processing and the graphic processing need completing the three processings in 1/30 second per one still image.

If it takes much time for the graphic processing due to a large quantity of image information, the moving image processing circuit may not complete the three processings in 1/30 second. If the moving image processing circuit may not complete, so-called “drop frame,” i.e., a frame which is not displayed, is produced. If the drop frame is produced at random, the moving image becomes unstable.

In a known moving image processing circuit, the decode processing, the color space conversion processing and the graphic processing employ a first-in and first-out (FIFO) system, so that it is hardly possible to determine which frame is dropped, resultantly, an unstable moving image is outputted to a display apparatus. Particularly, in a portable moving-image display apparatus such as a cellular phone, a capacity of a memory mounted therein is limited, which is apt to generate an unstable moving image.

Japanese Patent Application Laid-Open Publication No. 2003-150141 discloses a method in which moving image data encoded by a predetermined compression method is stored in an input buffer, decoded YUV signal data is stored in an intermediate buffer and color-space converted RGB data is stored in an output buffer, and decode processing, color-space conversion processing and output processing are performed in parallel.

The method disclosed in Japanese Patent Application Laid-Open Publication No. 2003-150141, however, relates to the decode processing and the color-space conversion processing and mentions nothing about the graphic processing requiring a larger load.

### BRIEF SUMMARY OF THE INVENTION

According to one aspect of the present invention, a moving image processing circuit is provided includes: a decode processing unit configured to decode moving image data encoded by a predetermined compression method; a color space conversion processing unit configured to convert the color space of the moving image data decoded by the decode processing unit to a different color space; a graphic processing unit configured to graphically process the moving image data whose color space is converted by the color space conversion processing unit; and a control unit configured to control the decode processing unit, the color space conversion processing unit and the graphic processing unit.

### BRIEF DESCRIPTION OF THE DRAWINGS

FIG. 1 is an external view of a cellular phone including a moving image processing circuit according to an embodiment;

FIG. 2 is a diagram illustrating the configuration of a video processing unit including the moving image processing circuit according to the embodiment;

FIG. 3 is a diagram illustrating the configuration of the moving image processing circuit according to the embodiment;

FIG. 4 is a diagram describing a frame buffer used by the moving image processing circuit according to the embodiment;

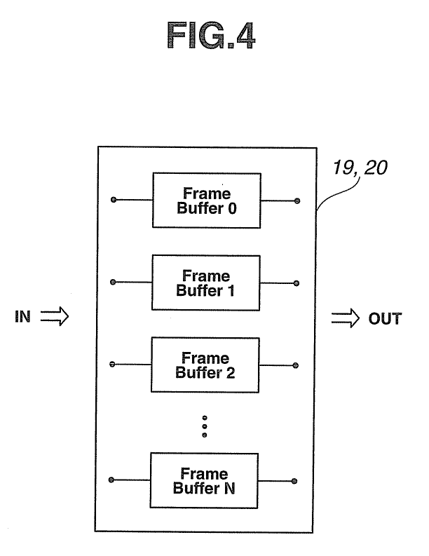

FIG. 5 is a flow chart for describing the flow of processing in the moving image processing circuit according to the embodiment;

FIG. 6 is a diagram describing a drop frame in the moving image processing circuit according to the embodiment; and

FIG. 7 is a diagram illustrating the configuration of the moving image processing circuit according to the embodiment.

### DETAILED DESCRIPTION OF THE PREFERRED EMBODIMENTS

An embodiment of the present invention will be described below with reference to the drawings.

### [Configuration of Moving Image Processing Circuit]

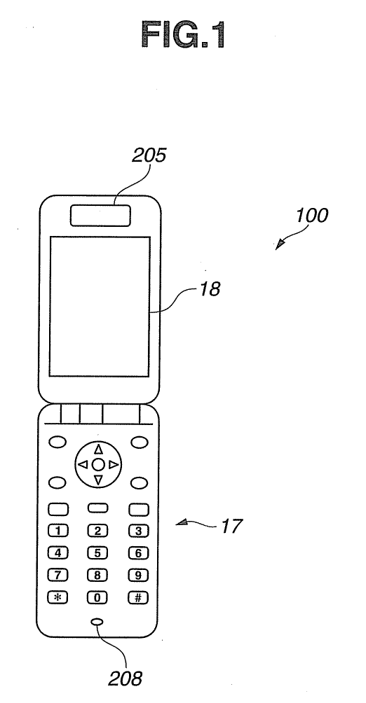

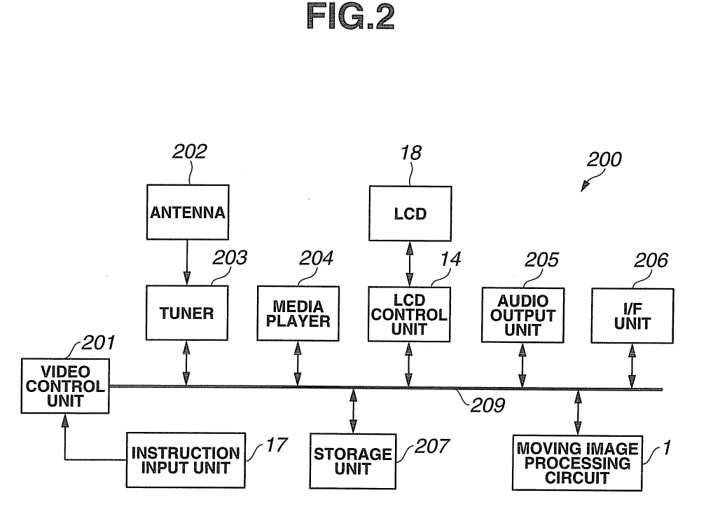

The configuration of a cellular phone 100 will be described including a moving image processing circuit 1 according to the present embodiment of the present invention and a video processing unit 200 of the cellular phone 100 with reference to FIGS. 1 and 2. FIG. 1 is an external view of the cellular phone 100 including the moving image processing circuit 1 according to the present embodiment. FIG. 2 is a diagram illustrating the configuration of the video processing unit 200 including the moving image processing circuit 1.

As illustrated in FIG. 1, the cellular phone 100 includes an LCD 18 being a display unit, an instruction input unit 17 through which a user inputs various instructions, an audio output unit 205 being a loudspeaker, an audio input unit 208 being a microphone and an antenna 202 (refer to FIG. 2) for a tuner.

The cellular phone 100 has a function as a moving image display apparatus as well as a function as a typical cellular phone. The cellular phone 100 receives, for example, a digital television broadcast wave, subjects the wave to graphic processing desired by the user and displays the wave on the LCD 18 being the display unit.

The configuration of the video processing unit 200 including the moving image processing circuit 1 will be described using FIG. 2.

A video control unit 201 controls the units in the video processing unit 200 to select a tuner, manage file systems of audio and video contents, control encoding and decoding, set a reproduction mode or control a user interface.

The instruction input unit 17 outputs an operation signal to the video control unit 201 in response to the user operating a switch.

The tuner 203 selects a channel signal among digital signals of one-segment broadcasting received by the antenna 202 and outputs digital video data.

A storage unit 207 stores management data required for managing contents such as firmware for operating the video control unit 201, application programs needed for reproduction and control, program setting data and video, and contents data such as video.

An LCD control unit 14 includes a backlight and an LCD controller and controls an LCD 18 by inputting data according to a display screen in response to the user operation from the video control unit 201 through a bus 209.

An audio output unit 205 amplifies an audio signal in the amplifier incorporated therein and outputs the amplified signal.

A media player 204 transfers information to and from an external storage medium such as a NAND flash memory.

An interface (I/F) unit 206 includes a USB terminal and an extension connector and controls the input and output of data when the I/F unit 206 is connected to an external apparatus.

The moving image processing circuit 1 processes video data outputted from a tuner 203 and the like as described later.

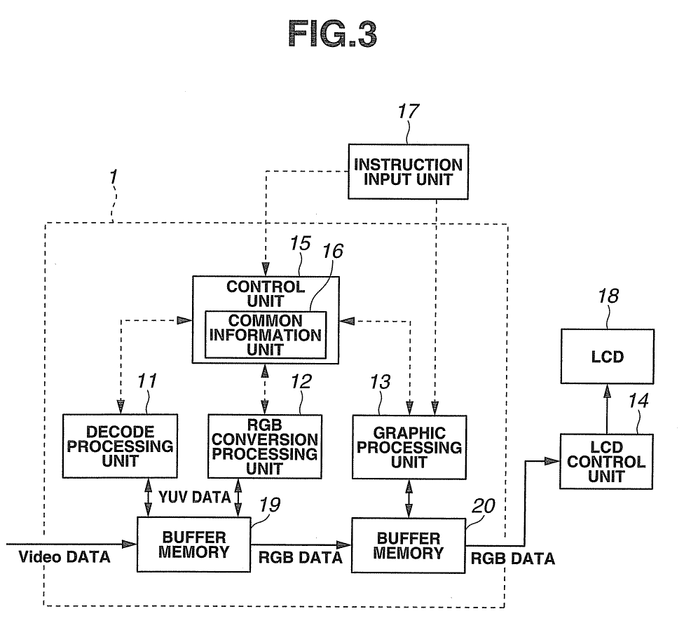

The configuration of the moving image processing circuit 1 according to the present embodiment will be described below using FIG. 3. FIG. 3 is a diagram illustrating the configuration of the moving image processing circuit 1 according to the present embodiment.

As illustrated in FIG. 3, the moving image processing circuit 1 includes a decode processing unit 11 configured to decode digital video data encoded by a predetermined compression method, i.e., moving image data and output YUV data, an RGB conversion processing unit 12 being a color space conversion processing unit configured to convert YUV data to RGB data being color space different from YUV data and output RGB data, a graphic processing unit 13 configured to graphically process the RGB data and output the processed data to the LCD 18 being a display unit through an LCD control unit 14, a control unit 15 configured to control the decode processing unit 11, the RGB conversion processing unit 12 and the graphic processing unit 13 and buffer memories 19 and 20.

The decode processing unit 11 subjects the digital video signal inputted thorough a digital broadcast signal to, for example, frequency deinterleave processing and time deinterleave processing and then to Viterbi decoding processing and Reed-Solomon decoding processing and outputs YUV data on a frame basis.

The color space of an image signal is described below. RGB using luminance information of Red, Green and Blue being three optical primary colors is the basic concept of the color space and has been widely used in a computer graphics field. On the other hand, YUV has been widely used in a broadcast field requiring efficiently transmitting video to a large number of viewers because the broadcast field needs not only to improve picture quality of video, but also to reduce data quantity required for recording and handling video. The YUV is a color space in which luminance information (Y) and two color difference information (blue-luminance (U) and red-luminance (V)) are used to represent color. The YUV takes advantage of the characteristic that the human eye is more sensitive to change in brightness than change in color to suppress chromaticity and allocate a wider band and a bit number to luminance, thereby enabling efficient transmission and compression with a small loss.

In the present embodiment, the term “YUV” is not limited to a narrowly-defined YUV, but means various color spaces consisting of luminance information and two color difference information, i.e., the color space being a color difference component such as, for example, YUV, YIQ, YCC (YCbCr) or YPbPr. The YIQ is used in the NTSC television broadcast, the YUV or the YCC is used in the PAL television broadcast and a JPEG image in the JFIF-format. Incidentally, the YUV is a traditional name in the current digital video field, actually however, refers to the YCbCr.

The color space of the image signal of digital video inputted to the RGB conversion processing unit 12 according to the present embodiment is the YUV. For this reason, the RGB conversion processing unit 12 converts the YUV data to the RGB data to allow graphic processing by the graphic processing unit 13.

The graphic processing unit 13 processes the inputted moving image under instructions from the upper applications. The instructions from the upper applications are inputted by the user through the instruction input unit 17, for example. The processing of a moving image performed by the graphic processing unit 13 is, for example, three-dimensional processing.

The RGB data processed by the graphic processing unit 13 is outputted to a liquid crystal display being a display unit, i.e., the LCD 18 through the LCD control unit 14 with an LCD controller.

The moving image processing circuit 1 according to the present embodiment includes the control unit 15 configured to control the decode processing unit 11, the RGB conversion processing unit 12 and the graphic processing unit 13. The control unit 15 controls the start of processing of any one of the decode processing unit 11, the RGB conversion processing unit 12 or the graphic processing unit 13 based on information from a common information unit 16 according to a predetermined preferential order. In other words, in the moving image processing circuit 1, the decode processing unit 11, the RGB conversion processing unit 12 and the graphic processing unit 13 do not employ the conventional FIFO system, namely, do not start processing the following frame until a control signal instructing to start processing from the control unit 15 is inputted.

More specifically, as illustrated in FIG. 3, the number of frame buffers in the buffer memories 19 and 20 being the frame buffer used by the moving image processing circuit 1 is (N+1) with 0 to N, i.e., finite. In the moving image processing circuit 1, the control unit 15 selects the frame for starting the following process among the frames stored in the frame buffer based on a predetermined preferential order and the information on each frame in the common information unit 16. If the preferential order in the moving image processing circuit 1 is based on time information of moving image data, i.e., a frame, the frame stored in the frame buffer prior to the selected frame is not subjected to the following process, which is referred to as drop frame.

In other words, the predetermined preferential order in the moving image processing circuit 1 is based on time information of moving image data or information on processing time of the decode processing unit 11, the RGB conversion processing unit 12 or the graphic processing unit 13 and instructed by the upper applications or the user through the instruction input unit 17, for example. The time information of moving image data refers to presentation time stamp (PTS) information of each frame forming the moving image data. If the time information is used as the preferential order, the latest frame is preferentially processed.

Information on processing time of the decode processing unit 11, the RGB conversion processing unit 12 or the graphic processing unit 13 is the number of frame buffers, limited processing time preset by the upper applications or processing time actually spent by each processing unit in processing the preceding frame and is stored in the common information unit 16. If information on the processing time is used as the preferential order, a processing best suited for the most time consuming processing is performed, and in most cases, a processing best suited for the processing of the graphic processing unit 13 is performed.

Frame information processed by the decode processing unit 11, the RGB conversion processing unit 12 and the graphic processing unit 13 is inputted to the common information unit 16 in real time. The control unit 15 selects a processing unit starting any one of processings among information in the common information unit 16. Although the common information unit 16 is illustrated as part of the control unit 15 in FIG. 3, the common information unit 16 may be a unit separated from the control unit 15. Although the buffer memory 19 is illustrated as a buffer memory commonly used for the decode processing unit 11 and the RGB conversion processing unit 12, the decode processing unit 11 and the RGB conversion processing unit 12 may use respective independent buffer memories. Alternatively, the decode processing unit 11, the RGB conversion processing unit 12 and the graphic processing unit 13 may use one common buffer memory.

### [Processing of Moving Image Processing Circuit]

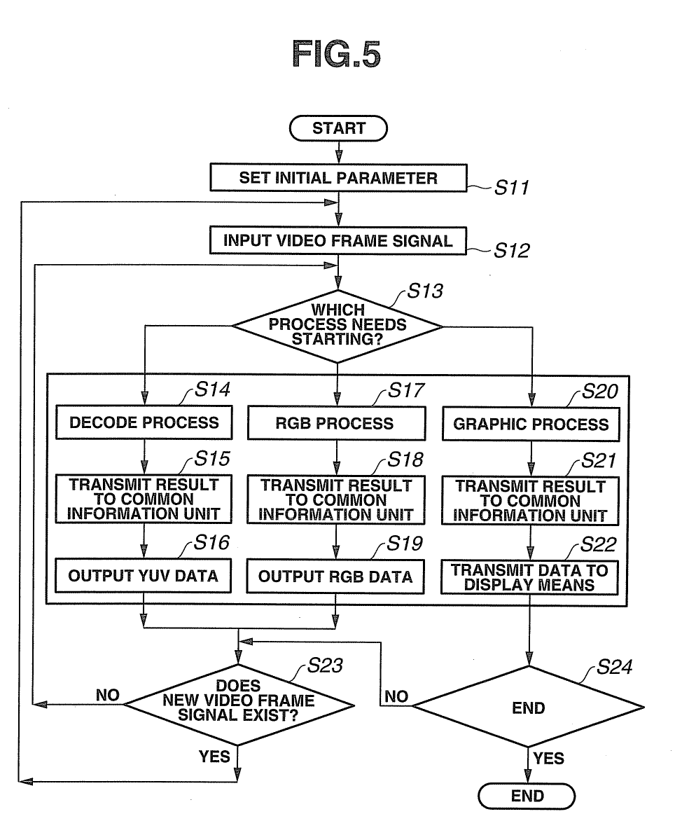

The flow of image signal processing in the moving image processing circuit 1 according to the present embodiment will be described below with reference to FIG. 5. FIG. 5 is a flow chart for describing the flow of processing in the moving image processing circuit 1 according to the present embodiment.

### [Step S11]

An initial parameter is inputted to the control unit 15 of the moving image processing circuit 1 from the instruction input unit 17 or upper applications to initialize the control unit 15. The initial parameter is parameter information on the preferential order which the control unit 15 uses for control. At the same time, the contents of graphic processing performed by the graphic processing unit 13 are inputted to the control unit 15 from the upper applications through the instruction input unit 17.

### [Step S12]

Digital video signal data is inputted to the moving image processing circuit 1.

### [Step S13]

The control unit 15 of the moving image processing circuit 1 determines which processing is started in the decode processing unit 11, the RGB conversion processing unit 12 or the graphic processing unit 13, according to a predetermined preferential order. Needless to say, only the decode processing can be started at the time of starting processing. As time elapses, a random drop frame does not occur because the control unit 15 determines which processing is started among three processings, thereby stabilizing the operation of the moving image processing circuit 1.

### [Steps S13 to S16]

If the control unit 15 selects the start of processing in the decode processing unit 11 and controls the decode processing unit 11, the decode processing unit 11 subjects the inputted digital video signal to the decode processing and outputs the YUV data on a frame basis. The decode processing unit 11 outputs processed frame information to the common information unit.

### [Steps S17 to S19]

If the control unit 15 selects the start of processing in the RGB conversion processing unit 12 and controls the RGB conversion processing unit 12, the RGB conversion processing unit 12 converts the YUV data outputted from the decode processing unit 11 to the RGB data and outputs the RGB data. The RGB conversion processing unit 12 outputs processed frame information to the common information unit.

### [Steps S20 to S22]

If the control unit 15 selects the start of processing in the graphic processing unit 13 and controls the graphic processing unit 13, the graphic processing unit 13 subjects the RGB data outputted from the RGB conversion processing unit 12 to a predetermined graphic processing in accordance with instructions received from the upper applications and outputs the graphically processed data to the LCD 18 through the LCD control unit 14. The graphic processing unit 13 outputs processed frame information to the common information unit.

The control unit 15 controls only the start of the above processings and can perform the processings at step 23 or later without waiting for the completion of each processing at steps S14 to S22.

### [Step S23]

If the following video data is inputted (Yes), the control unit 15 inputs the following video data at step S12. If the following video data is not inputted (No), the control unit 15 selects the processing started next at step S13.

As described above, the moving image processing circuit 1 according to the present embodiment includes the control unit 15 configured to control the decode processing unit 11, the RGB conversion processing unit 12 and the graphic processing unit 13, so that the three processings are not of FIFO system, but of the system in which the control unit 15 controls the start of processing. For this reason, the moving image processing circuit 1 enables stable moving-image processing.

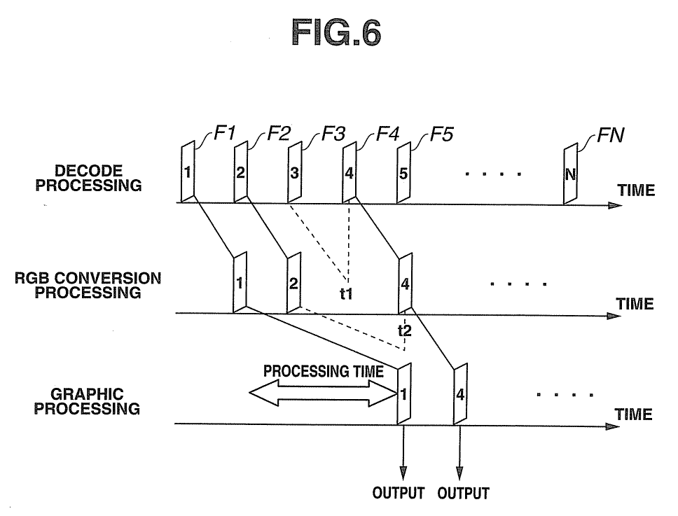

The drop frame in the moving image processing circuit 1 according to the present embodiment will be described below with reference to FIG. 6. FIG. 6 is a diagram describing a drop frame phenomenon. The abscissa in FIG. 6 represents elapsed time. Reference characters F1 to FN denote frame data on a frame basis. For the sake of simplicity in FIG. 6, the case is exemplified where the number of frame buffers is as extremely small as two.

If four frames of F1, F2, F3 and F4, for example, are processed in the decode processing unit, the frame F3 is not subjected to the RGB conversion processing at time t1 to lead to the drop frame, because the number of the frame buffers is only two. At time t2, the frame F2 is not subjected to the graphic processing to lead to the drop frame, because the frame F4 which is later than the frame F2 exists at the time of the graphic processing. The above is an example where the control unit 15 controls the start of processing in preference to the latest frame based on the time information of moving image data. In other words, the control unit 15 controls the start of processing of the decode processing unit 11, the RGB conversion processing unit 12 and the graphic processing unit 13 to select a frame leading to the drop frame. Thus, the moving image processing circuit 1 according to the present embodiment has a scheduling function for selecting a frame to be preferentially processed, in a system including an application, service or the like which performs graphic processing while performing decode processing at the same time on video signals on the frame basis. For this reason, the moving image processing circuit 1 does not output unstable moving image unlike a conventional moving image processing circuit which is apt to randomly cause the drop frame. For example, a so-called “freezing phenomenon” that a large number series of frames leads to the drop frame does not occur in the moving image processing circuit 1.

Thus, in the moving image processing circuit 1, the control unit 15 controls the start of processing of any one of the decode processing unit 11, the RGB conversion processing unit 12 or the graphic processing unit 13 according to the predetermined preferential order to enable a stable moving image processing desired by the upper applications or the user.

The moving image processing circuit 1 allows the latest frame to be preferentially displayed on the LCD 18 if the preferential order is based on time information of the moving image data. On the other hand, if the preferential order is based on information on processing time of the decode processing unit 11, the RGB conversion processing unit 12 or the graphic processing unit 13, the moving image processing circuit 1 performs the processing best suited for respective processings. Particularly, the best suited graphic processing is performed in the graphic processing unit 13, so that the user can view a desired graphically-processed moving image.

The use of the moving image processing circuit 1 of the present embodiment in a portable apparatus, particularly in a cellular phone whose mounted memory is limited in capacity achieves a marked effect. Specifically, the cellular phone 100 is equipped with the moving image processing circuit 1 including the decode processing unit 11 configured to decode moving image data encoded by the predetermined compression method, the color space conversion processing unit configured to convert the color space of the moving image data decoded by the decode processing unit 11 to a different color space, the graphic processing unit 13 configured to graphically process the moving image data whose color space is converted by the color space conversion processing unit and the control unit 15 configured to control the decode processing unit 11, the color space conversion processing unit and the graphic processing unit 13. The color space of the decoded image data is the YUV. The color space conversion processing unit in the moving image processing circuit 1 of the cellular phone 100 converts a signal whose color space is the YUV to a signal whose color space is the RGB. The control unit 15 in the moving image processing circuit 1 of the cellular phone 100 controls the start of processing of any one of the decode processing unit 11, the RGB conversion processing unit or the graphic processing unit 13 according to the predetermined preferential order. In the moving image processing circuit 1 of the cellular phone 100, the preferential order is based on time information of moving image data or information on processing time of the decode processing unit 11, the color space conversion processing unit or the graphic processing unit 13. In the moving image processing circuit 1 of the cellular phone 100, the moving image data encoded by the predetermined compression method is digital video data.

The moving image processing circuit 1 achieves a marked effect particularly at the time of three-dimensional processing a moving image.

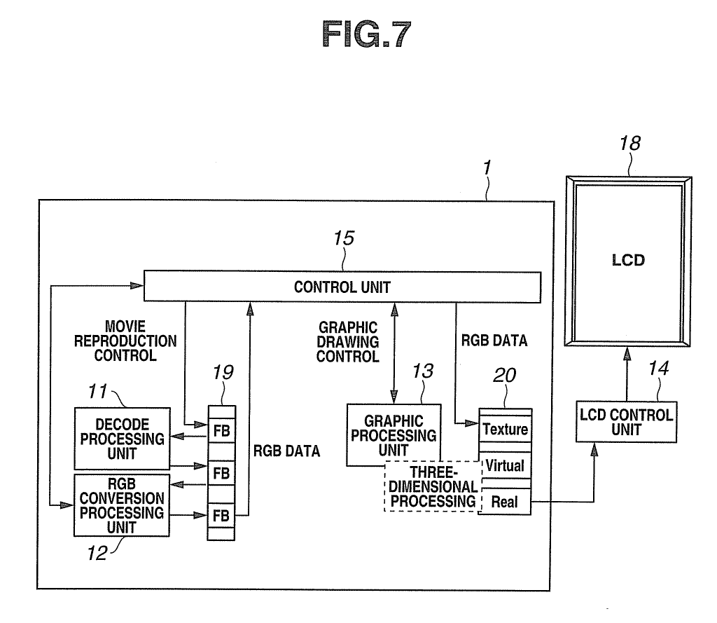

FIG. 7 is a diagram illustrating the configuration of a moving image processing circuit 2 being a modification of the moving image processing circuit 1 according to the present embodiment. Since the configuration and operation of the moving image processing circuit 2 are similar to those of the moving image processing circuit 1, the same composing elements are denoted with the same reference numerals to omit further description thereof.

The decode processing unit 11 of the moving image processing circuit 2 illustrated in FIG. 7 decodes inputted all moving image data by the FIFO system. The control unit 15 controls the start of processing of any of the RGB conversion processing unit 12 being the color space conversion processing unit or the graphic processing unit 13 according to a predetermined preferential order. Specifically, the moving image processing circuit 2 includes a decode processing unit configured to decode moving image data encoded by a predetermined compression method by the FIFO system, a color space conversion processing unit configured to convert the color space of the moving image data decoded by the decode processing unit to a different color space, a graphic processing unit configured to graphically process the moving image data whose color space is converted by the color space conversion processing unit and a control unit configured to control the color space conversion processing unit and the graphic processing unit. The decode processing unit of the moving image processing circuit 2 decodes the inputted moving image data by the FIFO system.

The moving image processing circuit 2 not only achieves the same effect as the moving image processing circuit 1, but is relatively simple in the operation of the control unit 15 to simplify the design of the moving image processing circuit.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A moving image processing circuit comprising:
a decode processing unit configured to decode moving image data encoded by a predetermined compression method;
a color space conversion processing unit configured to convert a color space of the moving image data decoded by the decode processing unit to a different color space;
a graphic processing unit configured to graphically process the moving image data whose color space is converted by the color space conversion processing unit; and
a control unit configured to control the decode processing unit, the color space conversion processing unit and the graphic processing unit.

2. The moving image processing circuit according to claim 1, wherein
the control unit controls the start of processing of any one of the decode processing unit, the color space conversion processing unit or the graphic processing unit according to a predetermined preferential order.

3. The moving image processing circuit according to claim 2, wherein
the control unit controls the start of the processing to select a frame leading to a drop frame.

4. The moving image processing circuit according to claim 2, wherein
the preferential order is based on time information of the moving image data or information on processing time of the decode processing unit, the color space conversion processing unit or the graphic processing unit.

5. The moving image processing circuit according to claim 4, wherein
the time information of the moving image data is PTS information.

6. The moving image processing circuit according to claim 1, wherein
the graphic processing unit subjects the moving image data to three-dimensional processing.

7. The moving image processing circuit according to claim 1, further comprising an instruction input unit through which a user inputs instructions for processing to the graphic processing unit.

8. The moving image processing circuit according to claim 1, wherein
the decode processing unit decodes the inputted moving image data by the FIFO method.

9. The moving image processing circuit according to claim 1, wherein
the moving image data encoded by the predetermined compression method is digital video data, the color space of image data to be decoded is the YUV color space and the color space conversion processing unit converts a YUV color-space signal to an RGB color-space signal.

10. A cellular phone comprising:
an antenna configured to receive a digital signal;
a tuner configured to select a channel signal among digital signals received by the antenna and output the moving image data encoded by a predetermined compression method;
a moving image processing circuit including a decode processing unit configured to decode the moving image data outputted by the tuner, a color space conversion processing unit configured to convert the color space of the moving image data decoded by the decode processing unit to a different color space, a graphic processing unit configured to graphically process the moving image data whose color space is converted by the color space conversion processing unit and a control unit configured to control the decode processing unit, the color space conversion processing unit and the graphic processing unit; and
a display unit configured to display the moving image data outputted by the moving image processing circuit.

11. The cellular phone according to claim 10, wherein
the control unit controls the start of processing of any one of the decode processing unit, the color space conversion processing unit or the graphic processing unit according to a predetermined preferential order.

12. The cellular phone according to claim 11, wherein
the control unit controls the start of the processing to select a frame leading to a drop frame.

13. The cellular phone according to claim 11, wherein
the preferential order is based on time information of the moving image data or information on processing time of the decode processing unit, the color space conversion processing unit or the graphic processing unit.

14. The cellular phone according to claim 13, wherein
the time information of the moving image data is PTS information.

15. The cellular phone according to claim 10, wherein
the graphic processing unit subjects the moving image data to three-dimensional processing.

16. The cellular phone according to claim 10, further comprising an instruction input unit through which a user inputs instructions for processing to the graphic processing unit.

17. The cellular phone according to claim 10, wherein
the decode processing unit decodes the inputted moving image data by the FIFO method.

18. The cellular phone according to claim 10, wherein
the moving image data encoded by the predetermined compression method is digital video data, the color space of image data to be decoded is the YUV color space and the color space conversion processing unit converts a YUV color-space signal to an RGB color-space signal.

19. A cellular phone comprising:
an antenna configured to receive a digital signal of digital broadcast;
a tuner configured to select a channel signal among digital signals received by the antenna and output the moving image data encoded by a predetermined compression method;
a moving image processing circuit including a decode processing unit configured to decode the moving image data outputted by the tuner, a color space conversion processing unit configured to convert the YUV moving image data decoded by the decode processing unit to the RGB moving image data, a graphic processing unit configured to apply a three-dimensional graphic processing to the RGB moving image data in which the color space is converted by the color space conversion processing unit and a control unit configured to control the decode processing unit, the color space conversion processing unit and the graphic processing unit and select a frame leading to a drop frame; and
a display unit configured to display the moving image data outputted by the moving image processing circuit.

20. The cellular phone according to claim 19, wherein
the control unit controls the start of processing of any one of the decode processing unit, the color space conversion processing unit or the graphic processing unit according to a predetermined preferential order.
